(19) United States
(12) Patent Application Publication
(10) Pub. No.: US 2021/0139138 A1
(43) Pub. Date: May 13, 2021

(54) METHODS AND SYSTEMS FOR REDUCING ROTOR ACOUSTICS OF AN AIRCRAFT

(71) Applicant: BETA AIR LLC, South Burlington, VT (US)

(72) Inventors: Kyle Clark, Underhill, VT (US); Lochie Ferrier, Burlington, VT (US)

(21) Appl. No.: 16/680,357

(22) Filed: Nov. 11, 2019

(51) Int. Cl. B64C 27/00; B64D 27/24; B64C 29/00; B64D 31/14; B64F 5/60; B64D 31/06; B64C 27/10

(52) U.S. Cl. CPC B64C 27/001; B64D 27/24; B64C 29/0025; B64C 2220/00; B64F 5/60; B64D 31/06; B64C 27/10; B64D 31/14

(57) ABSTRACT

A system for reducing rotor acoustics of an aircraft. The system includes a structural feature of an aircraft and a propulsor configured for fixed-wing flight mounted on the structural feature. The system further includes a plurality of rotors mounted on the structural feature. The plurality of rotors are configured to include a first rotor, a first motor mechanically coupled to the first rotor, a second rotor, and a second motor mechanically coupled to the second rotor. The system further includes an aircraft controller communicating with the first motor, second motor, and the propulsor. The system includes an alignment module configured to place the second rotor in alignment with the first rotor. The system further includes a rotational control module configured to initiate rotation of the plurality of rotors. Initiating rotation of the plurality of rotors further includes initiating rotation of the first rotor and the second rotor.

### FIELD OF THE INVENTION

The present invention generally relates to the field of rotor systems for an aircraft. In particular, the present invention is directed to methods and systems for reducing rotor acoustics of an aircraft.

### BACKGROUND

Historically, critical components of aircrafts and other machinery configured for flight have been susceptible to acoustic effects caused by harmonics associated with the rotational frequency of the critical components. Acoustic effects can be transmitted from the critical component to the body of the aircraft and/or other machinery configured for flight, resulting in periodic and/or random oscillation. The oscillations can result in fatigue to the pilot, crew, and/or passengers, damage to critical components of the aircraft and other machinery configured for flight, resulting in improper or limited functionality, and/or damage to the payload. The need for a means of correcting acoustic effects created and transmitted by critical components of aircrafts and other machinery configured for flight may be met by monitoring and modifying the rotational frequency of the critical component. The latter solution can be particularly attractive where an aircraft has a constant, intermittent, or occasional need for rotor-based flight, such as may be the case for an aircraft that takes off and/or lands vertically or may need to hover at certain points in the aircraft's flight.

### SUMMARY OF THE DISCLOSURE

In one aspect, a system for reducing rotor acoustics of an aircraft includes at least a structural feature of an aircraft. The system further includes at least a propulsor for fixed-wing flight on at least a structural feature of an aircraft. The system further includes a plurality of rotors mounted on the at least a structural feature. The at least a structural feature includes at least a first rotor, at least a first motor mechanically coupled to the at least a first rotor configured to cause the at least a first rotor to rotate when activated, at least a second rotor, and at least a second motor mechanically coupled to the at least a second rotor configured to cause the at least a second rotor to rotate when activated. The system further includes an aircraft controller in communication with the at least a first motor, the at least a second motor, and the at least a propulsor. The system further includes an alignment module operating on the aircraft controller. The alignment module is configured to place the at least a second rotor in alignment with the at least a first rotor when the at least a first rotor and the at least a second rotor are not rotating. The system further includes a rotational control module operating on the aircraft controller. The rotational control module is configured to initiate rotation of at least the plurality of rotors. The rotational control module includes initiating rotation of at least a first rotor at a first time and initiating rotation of at least a second rotor at a second time separated from the first time by a phase difference.

In another aspect, a method for reducing rotor acoustics of an aircraft comprises placing, by at least an alignment module operating on the aircraft controller, the at least a second rotor in alignment with the at least a first rotor when the at least a first rotor and the at least a second rotor are not rotating. Placing the at least a second rotor in alignment with the at least a first rotor further comprises detecting, by at least a relative wind sensor, the rotation of the at least a propulsor. Placing the at least a second rotor in alignment with the at least a first rotor further comprises determining, by at least a relative wind sensor, the relative wind to the aircraft and aligning the orientation of the plurality of rotors as a function of the relative wind sensor. The method further includes initiating, by at least a rotational control module operating on the aircraft controller, rotation of at least the plurality of rotors. Initiating rotation of at least the plurality of rotors further comprises initiating rotation of at least a first rotor at a first time and initiating rotation of at least a second rotor at a second time separated from the first time by a phase difference.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a high-level block diagram illustrating an exemplary embodiment of a system for reducing rotor acoustics of an aircraft;

FIG. 2 is a diagrammatic representation of an electric aircraft;

FIG. 3 is a schematic diagram depicting an aircraft incorporating the disclosed system;

FIG. 4 is a schematic diagram depicting an aircraft incorporating the disclosed system;

FIG. 5 is a block diagram depicting an exemplary embodiment of a portion of the disclosed system;

FIG. 6 is a schematic diagram illustrating an exemplary embodiment of an alignment module and associated system components;

FIG. 7 is a schematic diagram illustrating an exemplary embodiment of a rotational control module and associated system components;

FIG. 8A-B are graphs illustrating exemplary plots of in-phase rotation and out of phase rotation for the plurality of rotors in an embodiment;

FIG. 9 is a flow diagram illustrating an exemplary method for reducing rotor acoustics of an aircraft; and

FIG. 10 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At a high level, aspects of the present disclosure are directed to systems and methods for reducing rotor acoustics of an aircraft. Systems for reducing rotor acoustics of an aircraft may be integrated into any aircraft, electric aircraft and/or any vertical takeoff or landing aircraft. Embodiments of the systems and methods herein may reduce rotor acoustics of an aircraft by a novel process of monitoring and modifying the rotational frequency of the plurality of rotors. This novel system may result in a reduction of detrimental negative impacts to the aircraft, pilot, crew, and/or passengers, and/or payload caused by acoustic effects, such as cracking to the airframe, damage to the payload, premature engine wear, mechanical issues, pilot stress and/or fatigue, cracked and/or loose exhaust connections, and/or other variations of damage to critical components of the aircraft.

Referring now to the drawings, FIG. 1 illustrates an exemplary embodiment of a system 100 for reducing rotor acoustics of an aircraft. System for reducing rotor acoustics 100 includes at least a structural feature of an aircraft 104. At least a structural feature 104 may be any portion of an aircraft incorporating system 100, including any aircraft as described below. At least a structural feature 104 may include without limitation a wing, a spar, an outrigger, an airfoil, a fuselage, an empennage, or any portion thereof. As a non-limiting example, an airfoil may be any structure of the aircraft comprising a surface shaped to produce a lifting force that acts at right angles to the direction of the airstream and a dragging force that acts in the same direction as the airstream. As another non-limiting example, a fuselage may be the structure of the aircraft that encompasses and carries the pilot, crew, passengers, and/or payload. Persons skilled in the art, upon reviewing the entirety of this disclosure, will be aware of many possible features that may function as at least a structural feature 104. At least a structural feature 104 may be constructed of any suitable material or combination of materials, including without limitation metal such as aluminum, titanium, steel, or the like, polymer materials or composites, fiberglass, carbon fiber, wood, or any other suitable material. As a non-limiting example, structural feature may be constructed from additively manufactured polymer material with a carbon fiber exterior; aluminum parts or other elements may be enclosed for structural strength, or for purposes of supporting, for instance, vibration, torque or shear stresses imposed by at least a propulsor 108. Persons skilled in the art, upon reviewing the entirety of this disclosure, will be aware of various materials, combinations of materials, and/or constructions techniques.

With continued reference to FIG. 1, system 100 includes at least a propulsor 108 for fixed-wing flight on the at least a structural feature 104 of an aircraft. A propulsor, as used herein, is a component or device used to propel a craft by exerting force on a fluid medium, which may include a gaseous medium such as air or a liquid medium such as water. At least a propulsor 108 includes a thrust element. At least a thrust element may include any device or component that converts the mechanical energy of a motor, for instance in the form of rotational motion of a shaft, into thrust in a fluid medium. At least a thrust element may include, without limitation, a device using moving or rotating foils, including without limitation one or more rotors, an airscrew or propeller, a set of airscrews or propellers such as contra-rotating propellers, a moving or flapping wing, or the like. At least a thrust element may include without limitation a marine propeller or screw, an impeller, a turbine, a pump-jet, a paddle or paddle-based device, or the like. As another non-limiting example, at least a thrust element may include an eight-bladed pusher propeller, such as an eight-bladed propeller mounted behind the engine to ensure the drive shaft is in compression. Persons skilled in the art, upon reviewing the entirety of this disclosure, will be aware of various devices that may be used as at least a thrust element.

Still referring to FIG. 1, system 100 includes at least a plurality of rotors 112 mounted on the at least a structural feature 104. At least a plurality of rotors 112 includes at least a first rotor 116. At least a first rotor 116, as used herein, may include one or more blade or wing elements driven in a rotary motion to drive fluid medium in a direction axial to the rotation of the blade or wing element. At least a first rotor 116 may include a plurality of blade or wing elements. At least a first rotor 116 may include a mast or shaft coupled to the one or more blade or wing elements; mast or shaft may be driven by a motor as described in further detail below.

Continuing to refer to FIG. 1, at least a plurality of motors 112 further includes at least a first motor 120 mechanically coupled to the at least a first rotor 116. At least a first motor 120 is configured to cause the at least a first rotor 116 to rotate when activated. At least a first motor 120 may include without limitation, any electric motor, where an electric motor is a device that converts electrical energy into mechanical energy, for instance by causing a shaft to rotate. At least a first motor 120 may be driven by direct current (DC) electric power; for instance, at least a first motor 120 may include a brushed DC at least a first motor 120 or the like. At least a first motor 120 may be driven by electric power having varying or reversing voltage levels, such as alternating current (AC) power as produced by an alternating current generator and/or inverter, or otherwise varying power, such as produced by a switching power source. At least a first motor 120 may include, without limitation, brushless DC electric motors, permanent magnet synchronous at least a first motor 120s, switched reluctance motors, or induction motors. In addition to inverter and/or a switching power source, a circuit driving at least a first motor 120 may include electronic speed controllers (not shown) or other components for regulating motor speed, rotation direction, and/or dynamic braking.

With continued reference to FIG. 1, at least a plurality of rotors 112 further includes at least a second rotor 124. At least a second rotor 124, as used herein, may include one or more blade or wing elements driven in a rotary motion to drive fluid medium in a direction axial to the rotation of the blade or wing element. At least a second rotor 124 may include any rotor as described above in reference to the at least a first rotor 116.

Still referring to FIG. 1, at least a plurality of rotors 112 further includes at least a second motor 128 mechanically coupled to the at least a second rotor 124. At least a second motor 128 is configured to cause the at least a second rotor 124 to rotate when activated. At least a second motor 128 may include any motor as described above in reference to the at least a first motor 120.

Continuing to refer to FIG. 1, system 100 may include at least an energy source 132. At least an energy source 132 may include any device providing energy to at least a propulsor 108; in an embodiment, at least an energy source 132 provides electric energy to the at least a propulsor 108. At least an energy source 132 may include, without limitation, a generator, a photovoltaic device, a fuel cell such as a hydrogen fuel cell, direct methanol fuel cell, and/or solid oxide fuel cell, or an electric energy storage device; electric energy storage device may include without limitation a capacitor, an inductor, and/or a battery. Battery may include, without limitation a battery using nickel based chemistries such as nickel cadmium or nickel metal hydride, a battery using lithium ion battery chemistries such as a nickel cobalt aluminum (NCA), nickel manganese cobalt (NMC), lithium iron phosphate (LiFePO4), lithium cobalt oxide (LCO), and/or lithium manganese oxide (LMO), a battery using lithium polymer technology, or any other suitable battery. Persons skilled in the art, upon reviewing the entirety of this disclosure, will be aware of various devices of components that may be used as at least an energy source 132. System 100 may include multiple propulsion sub-systems, each of which may have a separate energy source 132 powering a separate at least a propulsor 108.

With continued reference to FIG. 1, system 100 includes at least an aircraft controller 136. Aircraft controller 136 may include and/or communicate with any computing device as described in this disclosure, including without limitation a microcontroller, microprocessor, digital signal processor (DSP) and/or system on a chip (SoC) as described in this disclosure. Aircraft controller 136 may be installed in an aircraft, may control the aircraft remotely, and/or may include an element installed in the aircraft and a remote element in communication therewith. Aircraft controller 136 may include, be included in, and/or communicate with a mobile device such as a mobile telephone or smartphone. Aircraft controller 136 may include a single computing device operating independently, or may include two or more computing device operating in concert, in parallel, sequentially or the like; two or more computing devices may be included together in a single computing device or in two or more computing devices. Aircraft controller 136 with one or more additional devices as described below in further detail via a network interface device. Network interface device may be utilized for connecting an aircraft controller 136 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Aircraft controller 136 may include but is not limited to, for example, an aircraft controller 136 or cluster of computing devices in a first location and a second computing device or cluster of computing devices in a second location. Aircraft controller 136 may include one or more computing devices dedicated to data storage, security, distribution of traffic for load balancing, and the like. Aircraft controller 136 may distribute one or more computing tasks as described below across a plurality of computing devices of computing device, which may operate in parallel, in series, redundantly, or in any other manner used for distribution of tasks or memory between computing devices. Aircraft controller 136 may be implemented using a “shared nothing” architecture in which data is cached at the worker, in an embodiment, this may enable scalability of system 100 and/or computing device.

Still referring to FIG. 1, at least an aircraft controller 136 is in communication with the at least a first motor 120, the at least a second motor 128, and the at least a propulsor 108. At least an aircraft controller 136 may be communicatively connected to the at least a first motor 120, the at least a second motor 128, and the at least a propulsor 108. As used herein, “communicatively connecting” is a process whereby one device, component, or circuit is able to receive data from and/or transmit data to another device, component, or circuit; communicative connection may be performed by wired or wireless electronic communication, either directly or by way of one or more intervening devices or components. In an embodiment, communicative connecting includes electrically coupling at least an output of one device, component, or circuit to at least an input of another device, component, or circuit. Communicative connecting may be performed via a bus or other facility for intercommunication between elements of a computing device as described in this disclosure. Communicative connecting may include indirect connections via “wireless” connection, radio communication, low power wide area network, optical communication, magnetic, capacitive, or optical coupling, or the like. Aircraft controller 136 may include any computing device or combination of computing devices as described in detail below in reference to FIG. 10. Aircraft controller 136 may include any processor or combination of processors as described below in reference to FIG. 10. Aircraft controller 136 may include a microcontroller. Aircraft controller 136 may be incorporated in an aircraft or may be in remote contact.

In an embodiment, and still referring to FIG. 1, aircraft controller 136 may include a reconfigurable hardware platform. A “reconfigurable hardware platform,” as used herein, is a component and/or unit of hardware that may be reprogrammed, such that, for instance, a data path between elements such as logic gates or other digital circuit elements may be modified to change an algorithm, state, logical sequence, or the like of the component and/or unit. This may be accomplished with such flexible high-speed computing fabrics as field-programmable gate arrays (FPGAs), which may include a grid of interconnected logic gates, connections between which may be severed and/or restored to program in modified logic. Reconfigurable hardware platform may be reconfigured to enact any algorithm and/or algorithm selection process received from another computing device and/or created using machine-learning and/or neural net processes as described below.

Continuing to refer to FIG. 1, system 100 includes at least an alignment module 140 operating on the at least an aircraft controller 136. At least an alignment module 140 may be instantiated to include any independently, merged, and/or shared hardware and/or software module as described in this disclosure. At least an alignment module 140 is configured to place the at least a second rotor 124 in alignment with the at least a first rotor 116 when the at least a first rotor 116 and the at least a second rotor 128 are not rotating. Alignment, as described herein, is the process of positioning the longitudinal axis, such as the axis extending from blade tip to blade root, for the at least a second rotor 124 in parallel with the longitudinal axis of the at least a first rotor 116. Alignment may include, for example and without limitation, orienting the at least a plurality of rotors 112 parallel and/or substantially parallel to the flight direction of the aircraft. Alignment may include, for example and without limitation, orienting the at least a plurality of rotors 112 parallel and/or substantially parallel to the longitudinal direction of the aircraft, such as the longitudinal axis of the fuselage, wherein the longitudinal axis of the fuselage may include the axis extending from the anterior fuselage to the posterior fuselage. As another non-limiting example, alignment may include orienting the at least a plurality of rotors 112 parallel to the direction of the relative wind relative to the at least a structural feature 104, such as the direction of the movement of the atmosphere relative to the airfoil.

With continued reference to FIG. 1, system 100 further includes at least a rotational control module 144 operating on the at least an aircraft controller 136. At least a rotational control module 144 may be instantiated to include any independently, merged, and/or shared hardware and/or software module as described in this disclosure. At least a rotational control module 144 is configured to initiate rotation of the at least a plurality of rotors 112. Initiating rotation of the at least a plurality of rotors 112 includes initiating rotation of the at least a first rotor 116. Initiating rotation of a plurality of rotors 112 further includes initiating rotation of at least a second rotor 124 at a second time separated from the first time by a phase difference. A phase difference, as described herein, is the difference between the phases of the at least a plurality of rotors 112 having the same frequency, such as a rotational lag of the second time of rotation of the second rotor 124 between 1 degree and 90 degrees of the first time of rotation of the first rotor 116.

Referring again to FIG. 1, aircraft controller 136 may be designed and/or configured to perform any method, method step, or sequence of method steps in any embodiment described in this disclosure, in any order and with any degree of repetition. For instance, aircraft controller 136 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Aircraft controller 136 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Now referring to FIG. 2, system 100 may be incorporated into an electrically powered aircraft 200. Electrically powered aircraft 200 may be an electric vertical takeoff and landing (eVTOL) aircraft. Electrically powered aircraft 200 may include at least a structural feature 104. Electrically powered aircraft 200 may include an aircraft controller 136 communicatively and/or operatively connected to each structural feature 104. Electrically powered aircraft 200 may be capable of rotor-based cruising flight, rotor-based takeoff, rotor-based landing, fixed-wing cruising flight, airplane-style takeoff, airplane-style landing, and/or any combination thereof. Rotor-based flight, as described herein, is where the aircraft generated lift and propulsion by way of one or more powered rotors coupled with an engine, such as a “quad copter,” multi-rotor helicopter, or other vehicle that maintains its lift primarily using downward thrusting propulsors. Fixed-wing flight, as described herein, is where the aircraft is capable of flight using wings and/or foils that generate life caused by the aircraft's forward airspeed and the shape of the wings and/or foils, such as airplane-style flight.

Continuing to refer to FIG. 2, an illustration of aerodynamic forces is illustrated in an electric aircraft. During flight, a number of aerodynamic forces may act upon the electric aircraft. Forces acting on an aircraft 200 during flight may include thrust, the forward force produced by the rotating element of the aircraft 200 and acts parallel to the longitudinal axis. Drag may be defined as a rearward retarding force which is caused by disruption of airflow by any protruding surface of the aircraft 200 such as, without limitation, the wing, rotor, and fuselage. Drag may oppose thrust and acts rearward parallel to the relative wind. Another force acting on aircraft 200 may include weight, which may include a combined load of the aircraft 200 itself, crew, baggage and fuel. Weight may pull aircraft 200 downward due to the force of gravity. An additional force acting on aircraft 200 may include lift, which may act to oppose the downward force of weight and may be produced by the dynamic effect of air acting on the airfoil and/or downward thrust from at least a propulsor 108. Lift generated by the airfoil may depends on speed of airflow, density of air, total area of an airfoil and/or segment thereof, and/or an angle of attack between air and the airfoil.

Referring now to FIG. 3, an embodiment of system 100 incorporated in an electric aircraft 200 is illustrated. Electric aircraft 200 may include a plurality of rotors 112a-d, which may include any rotor as described above in reference to FIG. 1. The plurality of rotors 112a-d may include the at least a first rotor and the at least a second rotor, which may include any rotor as described above. In an embodiment, the at least a first rotor may be configured to include any rotor of the plurality of rotors 112a-d. In an embodiment, the at least a second rotor may be configured to include any rotor of the plurality of rotors 112a-d not including the first rotor. For example, and without limitation, the at least a first rotor and the at least a second rotor may be configured to be laterally located, such as the at least a first rotor may be the rotor of the plurality of rotors 112a and the second rotor may be the rotor of the plurality of rotors 112b and/or the at least a first rotor may be the rotor of the plurality of rotors 112d and the at least a second rotor may be the rotor of the plurality of rotors 112c. As another example and without limitation, the at least a first rotor and the at least a second rotor may be configured to be horizontally located, such as the at least a first rotor may be the rotor of the plurality of rotors 112a and the at least a second rotor may be the rotor of the plurality of rotors 112d and/or the at least a first rotor may be the rotor of the plurality of rotors 112b and the at least a second rotor may be the rotor of the plurality of rotors 112c. As another non-limiting example, the at least a first rotor and the at least a second rotor may be configured to be diagonally located, such as the at least a first rotor may be the rotor of the plurality of rotors 112a and the at least a second rotor may be the rotor of the plurality of rotors 112c and/or the at least a first rotor may be the rotor of the plurality of rotors 112d and the at least a second rotor may be the rotor of the plurality of rotors 112b. Persons skilled in the art, upon reviewing the entirety of this disclosure, will be aware of various configurations of a first rotor and a second rotor that may be used as or included in system 100 or an electric aircraft 200, as used and described herein.

Referring now to FIG. 4, another embodiment of system 100 incorporated in an electric aircraft 200 is illustrated. Electric aircraft 200 may include a plurality of rotors, which may include any rotor as described above in reference to FIGS. 1-3. The plurality of rotors may include a plurality of coaxial rotors, wherein a coaxial rotor may include any rotor as described above. A coaxial rotor, as described herein, is a pair of rotors mounted one above the other, with the same axis of rotation, but turning in opposite directions. The plurality of coaxial rotors may include at least an upper rotor 400a-d and at least a lower rotor 404a-d, wherein the at least an upper rotor 400a-d and the at least a lower rotor 404a-d may include any rotor as described above in reference to FIGS. 1-3. The at least an upper rotor 400a-d may include the at least a first rotor and/or the at least a second rotor, wherein the at least a first rotor and the at least a second rotor may include any rotor as described above. The at least a lower rotor 404a-d may include the at least a first rotor and/or the at least a second rotor, wherein the first rotor and the at least a second rotor may include any rotor as described above. In an embodiment, the at least a first rotor may be configured to include any rotor of the plurality of coaxial rotors, such as upper rotor 400a-d and/or lower rotor 404a-d. In an embodiment, the at least a second rotor may be configured to include any rotor of the plurality of coaxial rotors not including the first rotor, such as upper rotor 400a-d and/or lower rotor 404a-d.

Continuing to refer to FIG. 4, for example, and without limitation, the at least a first rotor and the at least a second rotor may be configured above one the other, such as the at least a first rotor may be the at least an upper rotor 400a and the second rotor may be the at least a lower rotor 404a, the at least a first rotor may be the at least an upper rotor 400b and the at least a second rotor may be the at least a lower rotor 404b, the at least a first rotor may be the at least an upper rotor 400c and the at least a second rotor may be the at least a lower rotor 404c, and/or the at least a first rotor may be the at least an upper rotor 400d and the at least a second rotor may be the at least a lower rotor 404d. As another example, without limitation, the at least a first rotor and the at least a second rotor may be laterally located on the same plane, such as the at least a first rotor may be the at least an upper rotor 400a and the at least a second rotor may be the at least an upper rotor 400b, the at least a first rotor may be the at least a lower rotor 404a and the at least a second rotor may be the at least a lower rotor 404b, the at least a first rotor may be the at least an upper rotor 400d and the at least a second rotor may be the at least an upper rotor 400c, and/or the at least a first rotor may be the at least a lower rotor 404d and the at least a second rotor may be the at least a lower rotor 400c. As another non-limiting example, the at least a first rotor and the at least a second rotor may be horizontally located on the same plane, such as the at least a first rotor may be the at least an upper rotor 400a and the at least a second rotor may be the at least an upper rotor 400d, the at least a first rotor may be the at least a lower rotor 404a and the at least a second rotor may be the at least a lower rotor 404d, the at least a first rotor may be the at least an upper rotor 400b and the at least a second rotor may be the at least an upper rotor 400d, and/or the at least a lower rotor 404b and the at least a second rotor may be the at least a lower rotor 404c. As another non-limiting example, the at least and first rotor and the at least a second rotor may be configured to be diagonally located in the same plane, such as the at least a first rotor may be the at least an upper rotor 400a and the at least a second rotor may be the at least an upper rotor 400c, the at least a first rotor may be the at least a lower rotor 404a and the at least a second rotor may be the at least a lower rotor 404c, the at least a first rotor may be the at least an upper rotor 400d and the at least a second rotor may be the at least an upper rotor 400b, and/or the at least a first rotor may be the at least a lower rotor 404d and the at least a second rotor may be the at least a lower rotor 404b. As another non-limiting example, the at least a first rotor and the at least a second rotor may be configured to be diagonally located in varying planes, such as the at least a first rotor may be the at least an upper rotor 400a and the at least a second rotor may be the at least a lower rotor 404c, the at least a first rotor may be the at least a lower rotor 404a and the at least a second rotor may be the at least an upper rotor 400c, the at least a first rotor may be the at least an upper rotor 400d and the at least a second rotor may be the at least a lower rotor 404b, and/or the at least a first rotor may be the at least a lower rotor 404d and the at least a second rotor may be the at least an upper rotor 400b. Persons skilled in the art, upon reviewing the entirety of this disclosure, will be aware of various configurations of a first rotor and a second rotor that may be used as or included in system 100 or an electric aircraft 200, as used and described herein.

Referring now to FIG. 5, an embodiment of the at least a coaxial rotor 500 of the plurality of coaxial rotors. The at least a coaxial rotor 500 may include any rotor as described above in reference to FIGS. 1-4. The at least a coaxial rotor is configured to be mounted on the at least a structural feature 104, wherein the at least a structural feature 104 may include any structural feature as described above in reference to FIG. 1. The at least a coaxial rotor 500 includes the at least an upper rotor 400, wherein the at least an upper rotor 400 may include any rotor as described above. The at least a coaxial rotor 500 further includes at least an upper motor mechanically coupled to the at least an upper rotor, wherein the at least an upper motor 500 may include any motor as described above in reference to FIG. 1. The at least an upper motor 500 is configured to cause the at least an upper rotor 400 to rotate when activated. Activation, as described herein, may include any process and/or combination of processes that turn on and/or start rotation of the rotor. Activation may include as a non-limiting example, transition from fixed-wing flight to rotor-based flight, such as by a rotor phase sensor, as described herein. As another example, without limitation, activation may further include a manual start of the at least a rotor, such as by flipping a switch, pressing a button, utilizing a graphic user interface, pushing a lever, utilizing voice commands, and the like. As another non-limiting example, activation may be performed wirelessly over a network, such as network communication as described herein. Persons skilled in the art, upon reviewing the entirety of this disclosure, will be aware of various means of activation that may be used or included in system 100 or an electric aircraft 200, as used and described herein.

With continued reference to FIG. 5, the at least a coaxial rotor 500 further includes the at least a lower rotor 404. The at least a lower rotor 404 may include any rotor as described above in reference to FIGS. 1-4. The at least a coaxial rotor 500 further includes at least a lower motor 504 mechanically coupled to the at least a lower rotor 404, wherein the at least a lower motor 504 may include any motor as described above. The at least a lower motor 504 is configured to cause the at least a lower rotor 404 to rotate when activated. Activation, as described herein, may include any process and/or combination of processes that turn on and/or start rotation of the rotor, such as any means of activation as described above.

Referring now to FIG. 6, an exemplary embodiment of the at least an alignment module 140 is illustrated. At least an alignment module 140 may be instantiated to include any independently, merged, and/or shared hardware and/or software module as described in this disclosure. The at least an alignment module 140 is configured to operate on the at least an aircraft controller 136. The at least an alignment module 140 is further configured to be communicatively connected to the at least a plurality of rotors 112 and/or the at least a propulsor 108, wherein the communicative connection is any means of communicatively connecting as described above. At least an alignment module 140 is configured to place the at least a second rotor in alignment with the at least a first rotor when the at least a first rotor and the at least a second rotor are not rotating. Alignment, as described herein, is the process of positioning the longitudinal axis, such as the axis extending from blade tip to blade root, for the at least a second rotor in parallel with the longitudinal axis of the at least a first rotor, as described above in reference to FIG. 1. Aspects of the present disclosure can be used to C. Aspects of the present disclosure can also be used to D. This is so, at least in part, because E.

With continued reference to FIG. 6, the at least an alignment module 140 includes at least a relative wind sensor 600. Relative wind sensor 600 may be instantiated as one sensor and/or a combination of sensors. Sensors, as described herein, are any device, module, and/or subsystems, utilizing any hardware, software, and/or any combination thereof to detect events and/or changes in the instant environment and communicate the information to the at least an aircraft controller. Relative wind sensor 600 may be configured to detect rotation of the at least a propulsor for fixed-wing flight. Fixed-wing flight occurs where the aircraft is capable of flight using wings and/or foils that generate life caused by the aircraft's forward airspeed and the shape of the wings and/or foils, as described above in reference to FIG. 2. Detection of rotation of the at least a propulsor, as described herein, is identifying the initiation of rotation of the at least a propulsor 108, wherein initiation of the at least a propulsor 108 signifies initiation of fixed-wing flight of the aircraft. Detection of rotation of the at least a propulsor may further include, for example and without limitation, detection of rotation of a plurality of propulsors. Persons skilled in the art, upon reviewing the entirety of this disclosure, will be aware of various ways to detect rotation of at least a propulsor that may be used or included in system 100 or an electric aircraft 200, as used and described herein.

Still referring to FIG. 6, relative wind sensor 600, operating on the at least an alignment module 140, may be further configured to determine the direction of movement of the atmosphere relative to the aircraft, wherein the direction of movement of the atmosphere relative to the aircraft is the relative wind. Determining the direction of movement of the atmosphere relative to the aircraft, as described herein, is measuring the direction of movement of the airfoil and calculating the parallel but opposite direction, wherein the relative wind moves in a parallel but opposite direction to movement of the airfoil and/or aircraft. Persons skilled in the art, upon reviewing the entirety of this disclosure, will be aware of various means of determining the direction of movement of the atmosphere relative to the aircraft that may be used or included in system 100 or an electric aircraft 200, as used and described herein.

Referring now to FIG. 7, an exemplary embodiment of the at least a rotational control module 144 is illustrated. At least a rotational control module 144 may be instantiated to include any independently, merged, and/or shared hardware and/or software module as described in this disclosure. The at least a rotational control module 144 is configured to operate on the at least an aircraft controller 136. The at least a rotational control module 144 is further configured to be communicatively connected to the at least a plurality of rotors 112, wherein the communicative connection is any means of communicatively connecting as described above. At least a rotational control module 144 is configured to initiate rotation of the at least a plurality of rotors 112. Initiating rotation of the at least a plurality of rotors 112 includes initiating rotation of the at least a first rotor 116. Initiating rotation of a plurality of rotors 112 further includes initiating rotation of at least a second rotor 124 at a second time separated from the first time by a phase difference. A phase difference, as described herein, is the difference between the phases for each rotor of the plurality of rotors 124 having the same frequency, as described above in reference to FIG. 1.

With continued reference to FIG. 7, the at least a rotational control module 144 includes at least a rotor phase sensor 700. Rotor phase sensor 700 may be instantiated as one sensor and/or a combination of sensors. Sensors, as described herein, are any device, module, and/or subsystems, utilizing any hardware, software, and/or any combination thereof to detect events and/or changes in the instant environment and communicate the information to the at least an aircraft controller. Rotor phase sensor 700 may be configured to detect rotor-based flight of the aircraft. Rotor-based flight occurs when the aircraft generates lift and propulsion by way of one or more powered rotors coupled with an engine, as described above in reference to FIG. 2. Detection of rotor-based flight of the aircraft, as described herein, is identifying the initiation of rotation of at least a rotor of the plurality of rotors 112, wherein initiation of the rotor of the plurality of rotors 112 signifies rotor-based flight of the aircraft. Detection of rotor-based flight may further include, for example and without limitation, detection of the initiation of rotation of the at least a plurality of rotors 112. Persons skilled in the art, upon reviewing the entirety of this disclosure, will be aware of various ways to detect rotor-based flight that may be used or included in system 100 or an electric aircraft 200, as used and described herein.

Still referring to FIG. 7, the at least a rotational control module 144 further includes the at least an acoustic sensor 704. Acoustic sensor 704 may be instantiated as one sensor and/or a combination of sensors. Sensors, as described herein, are any device, module, and/or subsystems, utilizing any hardware, software, and/or any combination thereof to detect events and/or changes in the instant environment and communicate the information to the at least an aircraft controller. Acoustic sensor 704 may be configured to detect acoustic effects resulting from out of phase rotor rotation. Out of phase rotor rotation, as described herein, is when the at least a first rotor and the at least a second rotor are not separated by at least a phase difference during rotation. Out of phase rotor rotation may result in acoustic effects. The acoustic effects, as described herein, are vibrational effects, such as periodic and/or random oscillations, transmitted from the rotor of the aircraft and/or other structural features of the aircraft. The acoustic effects can result in fatigue to the pilot, crew, and/or passengers, damage to critical components of the aircraft and other machinery configured for flight, resulting in improper or limited functionality, and/or damage to the payload. Detection of acoustic effects resulting from out of phase rotor rotation, as described herein, is identifying irregular vibrations and/or oscillations of the at least a rotor. Identifying irregular vibrations and/or oscillations of the rotor may include, for example and without limitation, measuring the level of noise generated by the rotor, measuring the length of vibrations of the rotor, measuring the time of rotation of the rotor, measuring the speed of the rotors, and the like. Persons skilled in the art, upon reviewing the entirety of this disclosure, will be aware of various ways to detect acoustic effects resulting from out of phase rotors that may be used or included in system 100 or an electric aircraft 200, as used and described herein.

Continuing to refer to FIG. 7, acoustic sensor 704, operating on the at least a rotational control module 144, may be further configured to determine the rotor rotating out of phase. Determining the rotor rotating out of phase, as described herein, is identifying the rotor to be the cause of the acoustic effects, wherein identifying the rotor may include defining the at least a second rotor rotating by a distance greater and/or smaller than the set phase difference. Determining the rotor rotating out of phase may include, for example and without limitation, identifying the phase difference between rotors of 30 degrees and determining the at least a second rotor to have a distance separating the at least a second rotor from the at least a first rotor to be greater or lesser phase difference of 30 degrees. For example and without limitation, determining the rotor rotating out of phase may further include identifying the phase difference between rotors of 55 degrees and determining the at least a second rotor to have a distance separating the at least a second rotor from the at least a first rotor to be greater or lesser phase difference of 55 degrees. As another example and without limitation, determining the rotor rotating out of phase may include identifying the phase difference between rotors of 80 degrees and determining the at least a second rotor to have a distance separating the at least a second rotor from the at least a first rotor to be greater or lesser phase difference of 80 degrees. Persons skilled in the art, upon reviewing the entirety of this disclosure, will be aware of various ways to determine the rotator rotating out of phase that may be used or included in system 100 or an electric aircraft 200, as used and described herein.

Still referring to FIG. 7, acoustic sensor 704, operating on the at least a rotational control module 144, is further configured to adjust the phase difference to eliminate acoustic effects of the rotor determined to be the cause of the acoustic effects. Adjusting the phase difference to eliminate acoustic effects, as described herein, is the resetting of the rotor determined to be the cause of the acoustic effects to the set phase difference, wherein resetting the rotor may include re-initiating rotation of the at least a second rotor at a time separated from the rotation of the first rotor by the phase difference of the plurality of rotors 112. Adjusting the phase difference to eliminate acoustic effects of the rotor determined to be the cause of the acoustic effects may include, for example and without limitation, having identified the second rotor is rotating at the same rate of rotation of the first rotor and not at the set phase difference of 40 degrees, adjusting the second rotor to initiate rotation as the first rotor reaches 40 degrees. As another example and without limitation, adjusting the phase difference to eliminate acoustic effects of the rotor determined to be the cause of the acoustic effects may include having identified the second rotor is rotating at a rate of rotation 0.5 degrees behind the first rotor and not at the set phase difference of 40 degrees, adjusting the second rotor to initiate rotation as the first rotor reaches 40 degrees. Adjusting the phase difference to eliminate acoustic effects of the rotor determined to be the cause of the acoustic effects may include, as another example and without limitation, having identified the second rotor is rotating at a rate of rotation 0.25 degrees behind the first rotor and not at the set phase difference of 40 degrees, adjusting the second rotor to initiate rotation as the first rotor reaches 40 degrees. Persons skilled in the art, upon reviewing the entirety of this disclosure, will be aware of various ways to adjust the phase difference to eliminate acoustic effects that may be used or included in system 100 or an electric aircraft 200, as used and described herein.

Referring now to FIGS. 8A-B, graphs illustrating the at least a plurality of rotors 112 in phase rotation and the at least a plurality of rotors 112 out of phase rotation resulting in acoustic effects in exemplary embodiments. In other words, FIGS. 8A-B illustrate examples of plots of the rotation of the plurality of rotors 112 over time, wherein each rotor of the at least a plurality of rotors are in phase with the plurality of rotors 112 and out of phase with the plurality of rotors 112. Time, for the purpose of the examples of rotation in exemplary embodiments, may be represented by degrees of rotation. FIGS. 8A-B are illustrated for exemplary purposes and only include graphs that illustrate the rotational plots of the at least a first rotor 116 and the at least a second rotor 124; in an embodiment, system 100 may include a plurality of rotors 112, a plurality of coaxial rotors, and the like. As illustrated for instance as an exemplary embodiment in FIG. 8A, the rotational frequency of first rotor for varying degrees is represented by line 800, the line displayed as a solid line. Line 800 may fluctuate over the rotation of the at least first rotor as a function of the rate of rotation. As shown in FIG. 8A, the rotational frequency of second rotor for varying degrees is represented by line 804, the line displayed as a dotted and/or dashed line. Line 804 may fluctuate over the rotation of the at least a second rotor as a function of the rate of rotation.

With continued reference to FIG. 8A-B, the at least a first rotor and the at least a second rotor may be initiated with a separation of time, wherein the separation of time is defined as a phase difference. The phase difference is represented by degrees of separation. As shown in FIG. 8A, the phase difference represented as 808 may be a rotational lag of the second time of rotation of the second rotor between 1 degree and 90 degrees of the first time of rotation of the first rotor. For example and without limitation, the phase difference may include a 30 degree rotational lag of the second time of rotation of the second rotor and the first time of rotation of the first rotor, such as the first time of rotation of the first rotor beginning at 0 degrees and the second time of the second rotor beginning when the first rotor reaches 30 degrees, the first time of rotation of the first rotor beginning at 30 degrees and the second time of the second rotor beginning when the first rotor reaches 60 degrees, the first time of rotation of the first rotor beginning at 60 degrees and the second time of the second rotor beginning when the first rotor reaches 90 degrees, and the like. As another example and without limitation, the phase difference may include a 50 degree rotational lag of the second time of rotation of the second rotor and the first time of rotation of the first rotor, such as the first time of rotation of the first rotor beginning at 0 degrees and the second time of the second rotor beginning when the first rotor reaches 50 degrees, the first time of rotation of the first rotor beginning at 50 degrees and the second time of the second rotor beginning when the first rotor reaches 100 degrees, the first time of rotation of the first rotor beginning at 100 degrees and the second time of the second rotor beginning when the first rotor reaches 150 degrees, and the like. As another example and without limitation, the phase difference may include a 70 degree rotational lag of the second time of rotation of the second rotor and the first time of rotation of the first rotor, such as the first time of rotation of the first rotor beginning at 0 degrees and the second time of the second rotor beginning when the first rotor reaches 70 degrees, the first time of rotation of the first rotor beginning at 70 degrees and the second time of the second rotor beginning when the first rotor reaches 140 degrees, the first time of rotation of the first rotor beginning at 140 degrees and the second time of the second rotor beginning when the first rotor reaches 210 degrees, and the like. Persons skilled in the art, upon reviewing the entirety of this disclosure, will be aware of various phase differences that may be used or included in system 100, as used and described herein. As shown in FIG. 8A, the at least a first rotor and the at least a second rotor are in-phase. In-phase as described herein, is when the at least a first rotor and the at least a second rotor remain separated by at least a phase difference during rotation.

Continuing to refer to FIG. 8A-B, FIG. 8B illustrates the changes in the plot of the function rotation of the at least a first rotor and the at least a second rotor when the rotors become out of phase. Out of phase, as described herein, is when the at least a first rotor and the at least a second rotor are not separated by at least a phase difference during rotation. As shown in FIG. 8B, line 800 and line 804 are out of phase, such as the phase difference between the at least a first rotor and the at least a second rotor is at least less than 1 degree. The at least a phase difference of less than 1 degree may produce acoustic affects to the aircraft, as described above.

Referring now to FIG. 9, an exemplary embodiment of a method 900 of reducing rotor acoustics of an aircraft is illustrated. Step 905 requires a detection of rotor-based flight of the aircraft. Rotor-based flight of the aircraft may include flight where the aircraft generated lift and propulsion by way of one or more powered rotors coupled with an engine, as described above in reference to FIGS. 1-8. If NO, program flow continues on to step 925. If YES, the program flow continues on to step 910.

At step 910, and still referring to FIG. 9, rotational control module 144 operating on the aircraft controller 136 initiates rotation of the at least a first rotor 116 at a first time. Initiating rotation of the first rotor may include, any process of initiation as described above in reference to FIGS. 1-8. At step 915, rotational control module 144 operating on the aircraft controller 136 initiates rotation of at least a second rotor 124 at a second time separated from the first time by a phase difference. Initiating rotation of at least a second rotor may include, any process of initiation as described above in reference to FIGS. 1-8. A phase difference is the difference between the phases of the at least a plurality of rotors 112 having the same frequency, wherein the phase difference may include a rotational lag of the second time of rotation of the second rotor 124 between 1 degree and 90 degrees of the first time of rotation of the first rotor 116. The phase difference may include any phase difference as described above in reference to FIGS. 1-8.

Still referring to FIG. 9, step 920 requires a detection of rotation of the at least a propulsor 108 for fixed-wing flight. The at least a propulsor 108 may include any propulsor described above in reference to FIG. 1. Detection of rotation of the at least a propulsor 108 may include identifying the initiation of rotation of the at least a propulsor 108, wherein initiation of the at least a propulsor 108 signifies initiation of fixed-wing flight of the aircraft, as described above in reference to FIGS. 1-6. If YES, program flow continues on to step 930. If NO, program flow continues on to step 940.

Still viewing FIG. 9, step 925 additionally requires a detection of rotation of the at least a propulsor 108 for fixed-wing flight flowing to different results than step 920. The at least a propulsor 108 may include any propulsor described above in reference to FIG. 1. Detection of rotation of the at least a propulsor 108 may include identifying the initiation of rotation of the at least a propulsor 108, wherein initiation of the at least a propulsor 108 signifies initiation of fixed-wing flight of the aircraft, as described above in reference to FIGS. 1-6. If YES, program flow continues on to step 930. If NO, program flow continues back to step 903 to determine if rotor-based flight of the aircraft is detected.

Continuing to view FIG. 9, at step 930 relative wind sensor 600 operating on the at least an alignment module 140 determined the direction of the movement of the atmosphere relative to the aircraft, wherein the direction of the movement of the atmosphere relative to the aircraft is the relative wind. Determining the direction of movement of the atmosphere relative to the aircraft, as described herein, is measuring the direction of movement of the airfoil and calculating the parallel but opposite direction to determine the relative wind, as described above in reference to FIG. 6.

Still viewing FIG. 9, at step 935, the at least an alignment module 140 operating on the at least an aircraft controller 136 aligns the orientation of the plurality of rotor pairs as a function of the relative wind sensor 600. Aligning the orientation of the plurality of rotor pairs is the process of positioning the longitudinal axis, such as the axis extending from blade tip to blade root, for the at least a second rotor 124 in parallel with the longitudinal axis of the at least a first rotor 116 as a function of the relative wind sensor 600. Alignment may include any alignment as described above in reference to FIGS. 1-8, such as orienting the at least a plurality of rotors 112 parallel to the direction of the relative wind determined by the at least a relative wind sensor 600.

With continued reference to FIG. 9, step 940 requires a detection of acoustic effects. Acoustic effects, as described above, are vibrational effects, such as periodic and/or random oscillations, transmitted from the rotor of the aircraft and/or other structural features of the aircraft. Acoustic effects may include any acoustic effect as described above in reference to FIG. 7. Detection of an acoustic effect further includes identifying irregular vibrations and/or oscillations of the at least a rotor, as described above in reference to FIG. 7. If NO, program flow continues back to step 903 to determine if rotor-based flight of the aircraft is detected. If YES, program flow continues on to step 945.

Still viewing FIG. 9, at step 945 the at least an alignment module 140 operating on the at least an aircraft controller 136 adjusts the phase difference of the rotor determined to be causing the acoustic effects to eliminate acoustic effects. Adjusting the phase difference to eliminate acoustic effects may include the resetting of the rotor determined to be the cause of the acoustic effects to the set phase difference, wherein resetting the rotor may include re-initiating rotation of the at least a second rotor at a time separated from the rotation of the first rotor by the phase difference of the plurality of rotors 112. Adjusting the phase difference of a rotor to eliminate acoustic effects may include any process and/or combination of processes to adjust as described above in reference to FIG. 7.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 10 shows a diagrammatic representation of one embodiment of a computing device in the exemplary form of a computer system 1000 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1000 includes a processor 1004 and a memory 1008 that communicate with each other, and with other components, via a bus 1012. Bus 1012 may include any of several types of bus structures including, but not limited to, a memory bus, a memory controller, a peripheral bus, a local bus, and any combinations thereof, using any of a variety of bus architectures.

Memory 1008 may include various components (e.g., machine-readable media) including, but not limited to, a random-access memory component, a read only component, and any combinations thereof. In one example, a basic input/output system 1016 (BIOS), including basic routines that help to transfer information between elements within computer system 1000, such as during start-up, may be stored in memory 1008. Memory 1008 may also include (e.g., stored on one or more machine-readable media) instructions (e.g., software) 1020 embodying any one or more of the aspects and/or methodologies of the present disclosure. In another example, memory 1008 may further include any number of program modules including, but not limited to, an operating system, one or more application programs, other program modules, program data, and any combinations thereof.

Computer system 1000 may also include a storage device 1024. Examples of a storage device (e.g., storage device 1024) include, but are not limited to, a hard disk drive, a magnetic disk drive, an optical disc drive in combination with an optical medium, a solid-state memory device, and any combinations thereof. Storage device 1024 may be connected to bus 1012 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1024 (or one or more components thereof) may be removably interfaced with computer system 1000 (e.g., via an external port connector (not shown)). Particularly, storage device 1024 and an associated machine-readable medium 1028 may provide nonvolatile and/or volatile storage of machine-readable instructions, data structures, program modules, and/or other data for computer system 1000. In one example, software 1020 may reside, completely or partially, within machine-readable medium 1028. In another example, software 1020 may reside, completely or partially, within processor 1004.

Computer system 1000 may also include an input device 1032. In one example, a user of computer system 1000 may enter commands and/or other information into computer system 1000 via input device 1032. Examples of an input device 1032 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1032 may be interfaced to bus 1012 via any of a variety of interfaces (not shown) including, but not limited to, a serial interface, a parallel interface, a game port, a USB interface, a FIREWIRE interface, a direct interface to bus 1012, and any combinations thereof. Input device 1032 may include a touch screen interface that may be a part of or separate from display 1036, discussed further below. Input device 1032 may be utilized as a user selection device for selecting one or more graphical representations in a graphical interface as described above.

A user may also input commands and/or other information to computer system 1000 via storage device 1024 (e.g., a removable disk drive, a flash drive, etc.) and/or network interface device 1040. A network interface device, such as network interface device 1040, may be utilized for connecting computer system 1000 to one or more of a variety of networks, such as network 1044, and one or more remote devices 1048 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1044, may employ a wired and/or a wireless mode of communication. In general, any network topology may be used. Information (e.g., data, software 1020, etc.) may be communicated to and/or from computer system 1000 via network interface device 1040.

Computer system 1000 may further include a video display adapter 1052 for communicating a displayable image to a display device, such as display device 1036. Examples of a display device include, but are not limited to, a liquid crystal display (LCD), a cathode ray tube (CRT), a plasma display, a light emitting diode (LED) display, and any combinations thereof. Display adapter 1052 and display device 1036 may be utilized in combination with processor 1004 to provide graphical representations of aspects of the present disclosure. In addition to a display device, computer system 1000 may include one or more other peripheral output devices including, but not limited to, an audio speaker, a printer, and any combinations thereof. Such peripheral output devices may be connected to bus 1012 via a peripheral interface 1056. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for reducing rotor acoustics of an aircraft, the system comprising:
at least a structural feature of an aircraft;
at least a propulsor for fixed-wing flight on the at least a structural feature of an aircraft;
a plurality of rotors mounted on the at least a structural feature, wherein the at least a plurality of rotors includes:
at least a first rotor;
at least a first motor mechanically coupled to the at least a first rotor configured to cause the at least a first rotor to rotate when activated;
at least a second rotor; and
at least a second motor mechanically coupled to the at least a second rotor configured to cause the at least a second rotor to rotate when activated;
an aircraft controller in communication with the at least a first motor, the at least a second motor, and the at least a propulsor;
an alignment module operating on the aircraft controller, wherein the alignment module is configured to place the at least a second rotor in alignment with the at least a first rotor when the at least a first rotor and the at least a second rotor are not rotating; and
a rotational control module operating on the aircraft controller, wherein the rotational control module is configured to initiate rotation of at least the plurality of rotors, wherein initiation of the plurality of rotors includes:
initiating rotation of at least a first rotor at a first time; and
initiating rotation of at least a second rotor at a second time separated from the first time by a phase difference.

2. The system of claim 1, wherein the aircraft further comprises an electronic aircraft.

3. The system of claim 1, wherein the aircraft further comprises a vertical takeoff and landing aircraft.

4. The system of claim 1, wherein the plurality of rotors further comprises a plurality of coaxial rotors, wherein the coaxial rotors further include:
at least an upper rotor;
at least an upper motor mechanically coupled to the at least an upper rotor configured to cause the at least an upper rotor to rotate when activated;
at least a lower rotor; and
at least a lower motor mechanically coupled to the at least a lower rotor configured to cause the at least a lower rotor to rotate when activated.

5. The system of claim 1, wherein the at least a first rotor operating on the at least a rotational controller includes the at least an upper rotor or the at least a lower rotor.

6. The system of claim 1, wherein the at least a second rotor operating on the at least a rotational controller includes the at least an upper rotor or the at least a lower rotor.

7. The system of claim 1, wherein the alignment module operating on the aircraft controller is further configured to include at least a relative wind sensor, wherein the relative wind sensor is further configured to:
detect rotation of the at least a propulsor for fixed-wing flight; and
determine the direction of movement of the atmosphere relative to the aircraft.

8. The system of claim 1, wherein the alignment module is further configured to align the orientation of the plurality of rotors as a function of the relative wind sensor.

9. The system of claim 1, wherein the rotational control module is further configured to include at least a rotor phase sensor configured to detect rotor-based flight of the aircraft.

10. The system of claim 1, wherein the phase difference of the at least a second rotor operating on the at least a rotational control module further includes a rotational lag of the second time of rotation of the second rotor between 1 degree and 90 degrees of the first time of rotation of the first rotor.

11. The system of claim 1, wherein the rotational control module further includes an acoustic sensor, wherein the acoustic sensor is configured to:
detect acoustic effects resulting from out of phase rotor rotation;
determine the rotor rotating out of phase; and
adjust phase difference to eliminate acoustic effects of the rotor rotating out of phase.

12. A method for reducing rotor acoustics of an aircraft, the method comprising:
placing, by at least an alignment module operating on the aircraft controller, the at least a second rotor in alignment with the at least a first rotor when the at least a first rotor and the at least a second rotor are not rotating, wherein placing the at least a second rotor in alignment with the at least a first rotor further comprises:
detecting, by at least a relative wind sensor, the rotation of the at least a propulsor;
determining, by at least a relative wind sensor, the relative wind to the aircraft; and
aligning the orientation of the plurality of rotors as a function of the relative wind sensor; and
initiating, by at least a rotational control module operating on the aircraft controller, rotation of at least the plurality of rotors, wherein initiating rotation of the plurality of rotors comprises:
initiating rotation of at least a first rotor at a first time; and
initiating rotation of at least a second rotor at a second time separated from the first time by a phase difference.

13. The method of claim 12, wherein the aircraft further comprises an electronic aircraft.

14. The method of claim 12, wherein the aircraft further comprises a vertical takeoff and landing aircraft.

15. The method of claim 12, wherein the at least a first rotor further comprises the at least an upper rotor or the at least a lower rotor.

16. The method of claim 12, wherein the at least a second rotor further comprises the at least an upper rotor or the at least a lower rotor.

17. The method of claim 12, wherein determining, by at least a relative wind sensor, the relative wind to the aircraft further comprises:
receiving at least a signal containing the direction of movement of the aircraft; and
processing the at least a signal, wherein processing the at least a signal further comprises calculating the direction of movement of the atmosphere relative to the aircraft.

18. The method of claim 12, wherein initiating, by the at least a rotational control module operating on the aircraft controller, rotation of the at least a plurality of rotors further comprises detecting, by the at least a rotor phase sensor, rotor-based flight of the aircraft.

19. The method of claim 12, wherein initiating, by the at least a rotational control module operating on the aircraft controller, rotation of the at least a second rotor at a second time separated from the first time by a phase difference further comprises:
initiating second time of rotation of the second rotor by a rotational lag between 1 degree and 90 degrees of the first time of rotation of the first rotor.

20. The method of claim 12, wherein initiating, by the at least a rotational control module operating on the aircraft controller, rotation of the plurality of rotors further comprises:
detecting, by an acoustic sensor, acoustic effects resulting from in-phase rotor rotation;
determining the rotor rotating out of phase; and
adjusting rotor phase difference to eliminate acoustic effects.
